(19) United States
(12) Patent Application Publication
(10) Pub. No.: US 2019/0357319 A1
(43) Pub. Date: Nov. 21, 2019

(54) SENSOR SYSTEM FOR TEMPERATURE-REGULATING APPLIANCE

(71) Applicant: HATCO CORPORATION, Milwaukee, WI (US)

(72) Inventors: Nick Bassill, Milwaukee, WI (US); Fei Shang, Milwaukee, WI (US); Ishan Shah, Milwaukee, WI (US); Mark Gilpatric, Milwaukee, WI (US)

(73) Assignee: HATCO CORPORATION, Milwaukee, WI (US)

(21) Appl. No.: 16/415,943

(22) Filed: May 17, 2019

Related U.S. Application Data
(60) Provisional application No. 62/673,785, filed on May 18, 2018.
(60) Provisional application No. 62/673,781, filed on May 18, 2018.

(51) Int. Cl. H05B 6/06; H05B 6/12

(52) U.S. Cl. CPC H05B 6/062; H05B 1/0266; H05B 2213/07; H05B 6/1209

(57) ABSTRACT

A temperature-regulating appliance includes a housing, a plate, a thermal element, and a temperature sensor. The housing defines an internal chamber. The plate is coupled to the housing and encloses the internal chamber. The plate has a top surface and a bottom surface. The thermal element is positioned beneath the plate and within the internal chamber. The temperature sensor is at least one of (i) coupled to and positioned along the bottom surface of the plate or (ii) positioned proximate the top surface and disposed within the plate. The temperature sensor is configured to acquire temperature data regarding a temperature of at least one of (i) the plate or (ii) an item of cookware positioned along the top surface of the plate.

### CROSS-REFERENCE TO RELATED PATENT APPLICATIONS

This application (a) claims the benefit of U.S. Provisional Patent Application No. 62/673,781, filed May 18, 2018, and U.S. Provisional Patent Application No. 62/673,785, filed May 18, 2018, and (b) is related to (i) U.S. patent application Ser. No. ______ (Attorney Docket No. 032016-0202), filed May 17, 2019, which claims the benefit of U.S. Provisional Patent Application No. 62/673,762, filed May 18, 2018, (ii) U.S. patent application Ser. No. ______ (Attorney Docket No. 032016-0204), filed May 17, 2019, which claims the benefit of U.S. Provisional Patent Application No. 62/673,763, filed May 18, 2018, U.S. Provisional Patent Application No. 62/673,768, filed May 18, 2018, U.S. Provisional Patent Application No. 62/673,778, filed May 18, 2018, and U.S. Provisional Patent Application No. 62/673,780, filed May 18, 2018, and (iii) U.S. patent application Ser. No. ______ (Attorney Docket No. 032016-0205), filed May 17, 2019, which claims the benefit of U.S. Provisional Patent Application No. 62/673,769, filed May 18, 2018, U.S. Provisional Patent Application No. 62/673,772, filed May 18, 2018, and U.S. Provisional Patent Application No. 62/673,775, filed May 18, 2018, all of which are incorporated herein by reference in their entireties.

### BACKGROUND

Induction warmers and cookers often include a temperature feedback system. The temperature feedback system may be used for temperature control and for safety shutdown when an item being heated becomes too hot.

### SUMMARY

One embodiment relates to a temperature-regulating appliance. The temperature-regulating appliance includes a housing, a plate, a thermal element, and a temperature sensor. The housing defines an internal chamber. The plate is coupled to the housing and encloses the internal chamber. The plate has a top surface and a bottom surface. The thermal element is positioned beneath the plate and within the internal chamber. The temperature sensor is at least one of (i) coupled to and positioned along the bottom surface of the plate or (ii) positioned proximate the top surface and disposed within the plate. The temperature sensor is configured to acquire temperature data regarding a temperature of at least one of (i) the plate or (ii) an item of cookware positioned along the top surface of the plate.

Another embodiment relates to a temperature-regulating appliance. The temperature-regulating appliance includes a housing, a plate, a thermal element, and a sensor assembly. The housing defines an internal chamber. The plate is coupled to the housing and encloses the internal chamber. The plate has a top surface and a bottom surface. The plate defines an aperture that extends at least partially from the top surface through a thickness of the plate. The thermal element is positioned beneath the plate and within the internal chamber. The sensor assembly includes a holder and a temperature sensor. The holder is positioned within the aperture. The holder defines a sensor chamber. The temperature sensor is disposed within the sensor chamber such that the temperature sensor is positioned proximate the top surface of the plate. The sensor assembly is flush with the top surface of the plate.

Still another embodiment relates to a temperature-regulating appliance. The temperature-regulating appliance includes a housing, a plate, a thermal element, and a plurality of temperature sensors. The housing defines an internal chamber. The plate is coupled to the housing and encloses the internal chamber. The plate has a top surface and a bottom surface. The thermal element is positioned beneath the plate and within the internal chamber. The plurality of temperature sensors are positioned to acquire temperature data regarding a temperature of at least one of (i) the plate or (ii) an item of cookware positioned along the top surface of the plate. Each of the plurality of temperature sensors is positioned at a different distance from a center of the plate. The temperature data acquired by each of the plurality of temperature sensors facilitates estimating a diameter of the item of cookware positioned along the top surface of the plate.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of an appliance, according to an exemplary embodiment.

FIG. 2 is a schematic diagram of the appliance of FIG. 1, according to an exemplary embodiment.

FIG. 3 is a detailed cross-sectional view of a first sensor arrangement for the appliance of FIG. 1, according to an exemplary embodiment.

FIG. 4 is a detailed cross-sectional view of a second sensor arrangement for the appliance of FIG. 1, according to an exemplary embodiment.

FIG. 5 is a detailed cross-sectional view of a third sensor arrangement for the appliance of FIG. 1, according to an exemplary embodiment.

FIG. 6 is a detailed cross-sectional view of a fourth sensor arrangement for the appliance of FIG. 1, according to an exemplary embodiment.

FIG. 7 is a detailed cross-sectional view of a fifth sensor arrangement for the appliance of FIG. 1, according to an exemplary embodiment.

FIG. 8 is a detailed cross-sectional view of a sixth sensor arrangement for the appliance of FIG. 1, according to an exemplary embodiment.

FIG. 9 is a perspective view of the sixth sensor arrangement of FIG. 8, according to an exemplary embodiment.

FIGS. 10 and 11 are various views of the appliance of FIG. 1 having a plurality of sensors arranged in various positions, according to an exemplary embodiment.

FIG. 12 is a flow diagram of a method for controlling operation of an appliance, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an appliance (e.g., a countertop appliance, a portable appliance, a built-in appliance, an induction range, etc.) includes one or more thermal elements positioned to facilitate thermally regulating a temperature of an item of cookware disposed on a top surface of a plate of the appliance. The appliance include a sensor system including one or more temperature sensors. In some embodiments, the one or more temperatures sensors are disposed within the plate, proximate the top surface thereof. In some embodiments, the one or more temperature sensors are additionally or alternatively positioned along a bottom surface of the plate. In some embodiments, each of the one or more temperature sensors are positioned at various different distances from a center of the plate to facilitate estimating a size (e.g., diameter, etc.) of the item of cookware positioned on the plate.

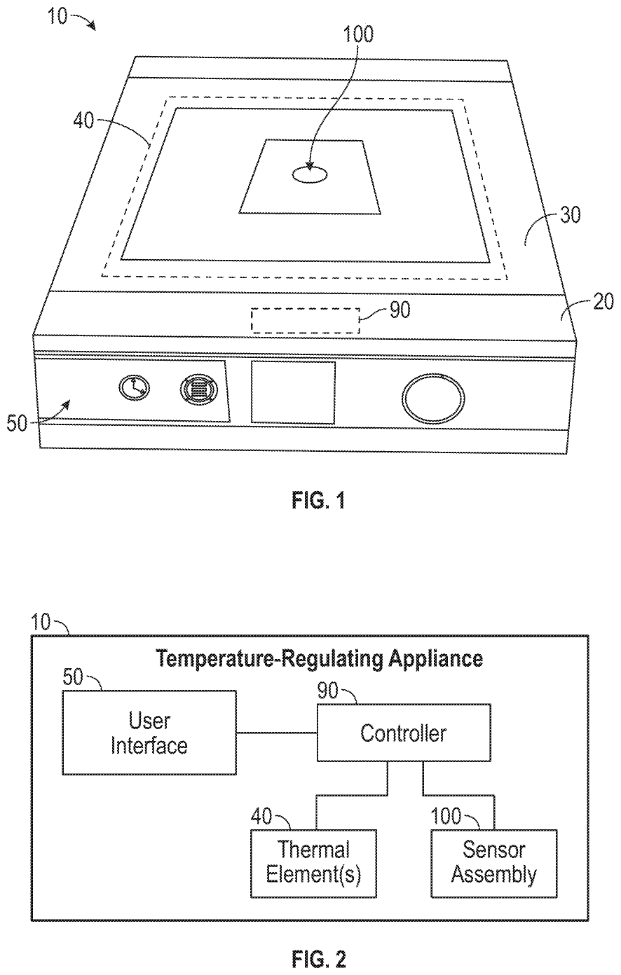

As shown in FIGS. 1-11, an appliance, shown as temperature-regulating appliance 10, includes a body, shown as housing 20, that defines an internal chamber; a support and/or cooking surface (e.g., a cooktop, a cooling plate, etc.), shown as top plate 30, coupled to the top of the housing 20 and enclosing the internal chamber thereof; a temperature-regulating element, shown as thermal element 40, disposed within the internal chamber of the housing 20, beneath the top plate 30; an interface, shown as user interface 50, coupled to the exterior of the housing 20; a sensor system, shown as sensor assembly 100, disposed within and/or coupled to the top plate 30; and a control system, shown as controller 90, disposed within the internal chamber of the housing 20 and coupled to the thermal element 40, the user interface 50, and the sensor assembly 100.

According to the exemplary embodiment shown in FIG. 1, the temperature-regulating appliance 10 is configured as a portable, tabletop appliance. In other embodiments, the temperature-regulating appliance 10 is configured as a built-in appliance (e.g., a stovetop appliance, built into a countertop, etc.). According to an exemplary embodiment, the temperature-regulating appliance 10 is an induction range. In other embodiments, the temperature-regulating appliance 10 is another type of appliance other than an induction range. By way of example, the temperature-regulating appliance 10 may be configured as a non-induction cooking, heating, or warming appliance such as an electric conductive appliance. By way of another example, the temperature-regulating appliance 10 may be configured as a cooling system configured to cool items disposed on the top plate 30.

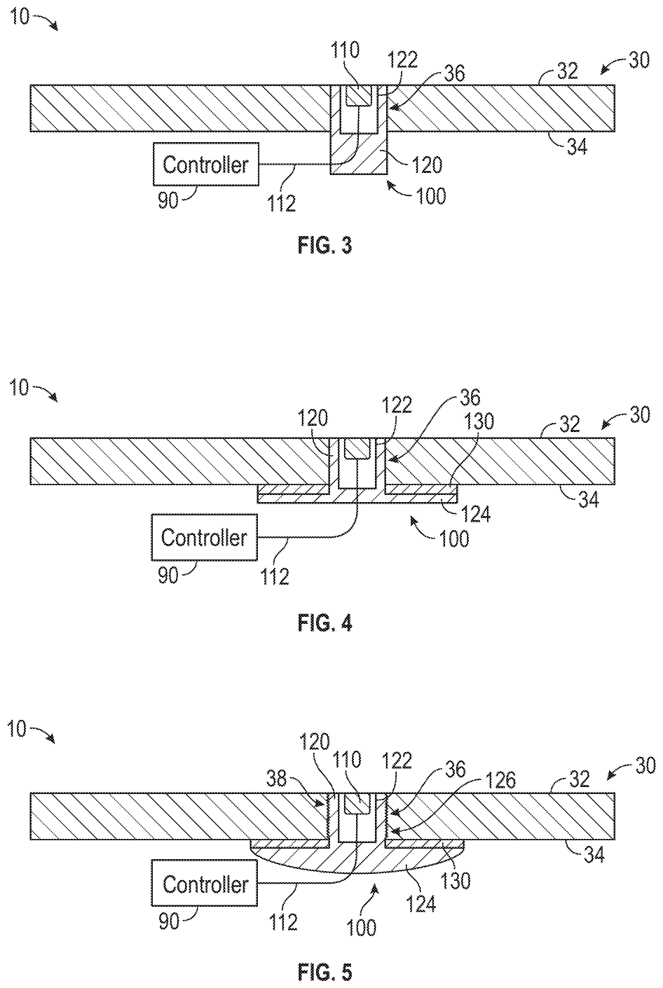

As shown in FIGS. 3-10, the top plate 30 has a first surface, shown as upper surface 32, and an opposing second surface, shown as lower surface 34. According to an exemplary embodiment, the top plate 30 is configured to support one or more pieces of cookware (e.g., pots, pans, kettles, etc.). In some embodiments, the top plate 30 is manufactured from a ceramic glass material. In other embodiments, the top plate 30 is manufactured from another material suitable for the heating, warming, and/or cooling operations disclosed herein (e.g., a metal or metal alloy, glass, ceramic, etc.). According to the exemplary embodiment shown in FIG. 1, the top plate 30 has a square shape with a width and height of twelve inches. However, it should be understood that the top plate 30 may have a variety of different shapes, sizes, colors, material compositions, and/or textures depending on the model and/or application of the temperature-regulating appliance 10. The top plate 30 may therefore have another shape such as an elongated rectangle, a circle, and/or any other suitable shape.

As shown in FIGS. 3-7, the top plate 30 defines an aperture, shown as through-hole 36, that extends completely through the upper surface 32 and the lower surface 34 at the center of the top plate 30. As shown in FIG. 5, the through-hole 36 defines retaining elements, shown as threads 38, along the length thereof. In some embodiments, while not shown, the through-hole 36 in FIGS. 3, 4, 6, and 7 includes the threads 38. In some embodiments, the top plate 30 defines a plurality of through-holes 36 (e.g., in embodiments where the sensor assembly 100 includes a plurality of temperature sensors, etc.). In such embodiments, each of the plurality of through-holes 36 may be defined along and through the top plate 30 is various designated locations, as described in more detail herein with respect to FIGS. 10 and 11. In some embodiments, as shown in FIG. 8, the top plate 30 does not define the one or more through-holes 36. In some embodiments, the top plate 30 does not define the one or more through-holes 36, but, rather, the upper surface 32 of the top plate 30 defines one or more apertures, recesses, cutouts, or notches that extend at least partially through the thickness of the top plate 30. In other embodiments, the lower surface 34 of the top plate 30 defines the one or more apertures, recesses, cutouts, or notches that extend at least partially through the thickness of the top plate 30.

According to an exemplary embodiment, the thermal element 40 is configured as an inductive heating element (e.g., an inductive heating coil, etc.) configured to facilitate cooking, heating, and/or warming cookware and/or food product disposed on the top plate 30 via inductive heating. In other embodiments, the thermal element 40 is configured as a non-inductive heating element (e.g., a conductive heating coil, etc.) configured to facilitate cooking, heating, and/or warming cookware and/or food product disposed on the top plate 30 via conductive heating. In still other embodiments, the thermal element 40 is configured as cooling element (e.g., a Peltier device, a thermoelectric cooler, etc.) configured to facilitate cooling cookware and/or food product disposed on the top plate 30 via conductive cooling. In some embodiments, the temperature-regulating appliance 10 includes a plurality of thermal elements 40 variously positioned within the housing 20 to facilitate variably cooking, heating, warming, and/or cooling cookware and/or food product disposed on the top plate 30. By way of example, the temperature-regulating appliance 10 may be configured to facilitate (i) heating, warming, and/or cooling a first piece of cookware and/or food product disposed on the top plate 30 to a first temperature and (ii) heating, warming, and/or cooling a second piece of cookware and/or food product disposed on the top plate 30 to a second temperature that is different than the first temperature. By way of another example, the thermal element 40 may include a plurality of induction elements, such as double or quad induction inverter and heating element arrangements.

According to an exemplary embodiment, the user interface 50 includes various input devices such as knobs, buttons, touch screens, display screens, etc. The various input devices may facilitate (i) an operator with providing various commands to the temperature-regulating appliance 10 (e.g., on, off, increase temperature, decrease temperature, setting a timer, etc.) and/or (ii) providing an operator with information regarding the operation of the temperature-regulating appliance 10 (e.g., current temperature of the cookware on the top plate 30, on status, off status, a timer, etc.).

As shown in FIGS. 7 and 8, the temperature-regulating appliance 10 includes an intermediate layer, shown as insulation 60, positioned beneath the lower surface 34 of the top plate 30. According to an exemplary embodiment, the insulation 60 is positioned between the top plate 30 and the thermal element 40. According to an exemplary embodiment, the insulation 60 is positioned to limit heat transfer from the top plate 30 to the internal chamber of the housing 20 (e.g., to prevent damage to sensitive electronic components disposed within the housing 20, etc.). As shows in FIGS. 7 and 8, the temperature-regulating appliance 10 includes one or more seals, shown as seals 62, positioned around the periphery of the top plate 30 and the insulation 60 to form a liquid-proof barrier or seal. Such a liquid-proof barrier or seal may prevent liquid from (i) seeping through the interface between (a) the top plate 30 and the insulation 60 and (b) the housing 20 and (ii) damaging the electronic components (e.g., the thermal element 40, the controller 90, etc.) disposed within the housing 20 (e.g., in the event that the top plate 30 becomes damaged or breaks, etc.). While not shown, it should be understood that the temperature-regulating appliance 10 shown in FIGS. 3-7 may include the insulation 60 and/or the seals 62.

According to the exemplary embodiment shown in FIGS. 7 and 8, the insulation 60 has a multi-layer construction including a first layer, shown as top layer 70, and a second layer, shown as bottom layer 80. In other embodiments, the insulation 60 has a different number of layers (e.g., three, four, etc.) and/or has a single-layer construction. According to an exemplary embodiment, the top layer 70 is manufactured from a first material and the bottom layer 80 is manufactured from a second material different than the first material. By way of example, the first material of the top layer 70 may be fiberglass and the second material of the bottom layer 80 may be mica. In some embodiments, a second layer of mica is positioned above the top layer 70 such that the fiberglass is sandwiched between two mica layers. In another embodiment, the top layer 70 and the bottom layer 80 are manufactured from the same material.

According to an exemplary embodiment, the controller 90 is configured to control operation of the thermal element 40 based on (i) user commands provided by the operator via the user interface 50 and/or (ii) sensor feedback signals from the sensor assembly 100 (e.g., temperature measurements, etc.) to heat and maintain cookware disposed on the top plate 30 at a desired temperature. The controller 90 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. The controller 90 may include a processing circuit having a processor and a memory. The processing circuit may include an ASIC, one or more FPGAs, a DSP, circuits containing one or more processing components, circuitry for supporting a microprocessor, a group of processing components, or other suitable electronic processing components. The processor may be configured to execute computer code stored in the memory to facilitate the activities described herein. The memory may be any volatile or non-volatile computer-readable storage medium capable of storing data or computer code relating to the activities described herein. The memory may include computer code modules (e.g., executable code, object code, source code, script code, machine code, etc.) configured for execution by the processor.

As shown in FIGS. 3-9, the sensor assembly 100 includes a single temperature sensor, shown as temperature sensor 110. In such embodiments, the temperature sensor 110 may be positioned at the center or proximate the center of the top plate 30 (e.g., slightly offset form the center, etc.). As shown in FIGS. 10 and 11, the sensor assembly 100 includes a plurality of the temperature sensors 110 variously positioned about the top plate 30. The arrangement and positioning of the plurality of the temperature sensors 110 is described in greater detail herein with respect to FIGS. 10 and 11. The temperature sensor(s) 110 may be or include a thermistor, a thermocouple, a resistance temperature detection (RTD) sensor, an infrared (IR) sensor, a negative temperature coefficient (NTC) thermistor, any other suitable temperature sensor, or any combination thereof. According to an exemplary embodiment, the temperature sensors 110 are configured to acquire temperature data regarding a temperature of the top plate 30 and/or one or more pieces of cookware disposed on the top plate 30. As shown in FIGS. 3-9 and 11, each of the temperature sensors 110 includes a connector, shown as lead wire 112, extending therefrom to the controller 90 to facilitate transmitting the temperature data to the controller 90 for processing and control operations performed thereby (see, e.g., method 1200). In some embodiments, the temperature sensors 110 do not include the lead wires 112, rather, the temperature sensors 110 may include wireless transmitters configured to wirelessly transmit the temperature data to the controller 90 (e.g., in embodiments where the top plate 30 defines recesses rather than the through-holes 36, etc.).

As shown in FIGS. 3-7, the sensor assembly 100 includes a sensor housing, shown as sensor holder 120, that is received by and positioned within the through-hole 36 of the top plate 30. According to an exemplary embodiment, the shape of the sensor holder 120 corresponds with the shape of the through-hole 36. As shown in FIGS. 3-7, the sensor holder 120 is cylindrical in shape. In other embodiments, the sensor holder 120 has another shape (e.g., rectangular, ovular, hexagonal, triangular, etc.) to correspond with a differently shaped through-hole 36. In some embodiments, the sensor holder 120 is manufactured from metal or a metal alloy. In some embodiments, the sensor holder 120 is manufactured from a ceramic material. In other embodiments, the sensor holder 120 is manufactured from another suitable material that can withstand the elevated temperatures of the top plate 30.

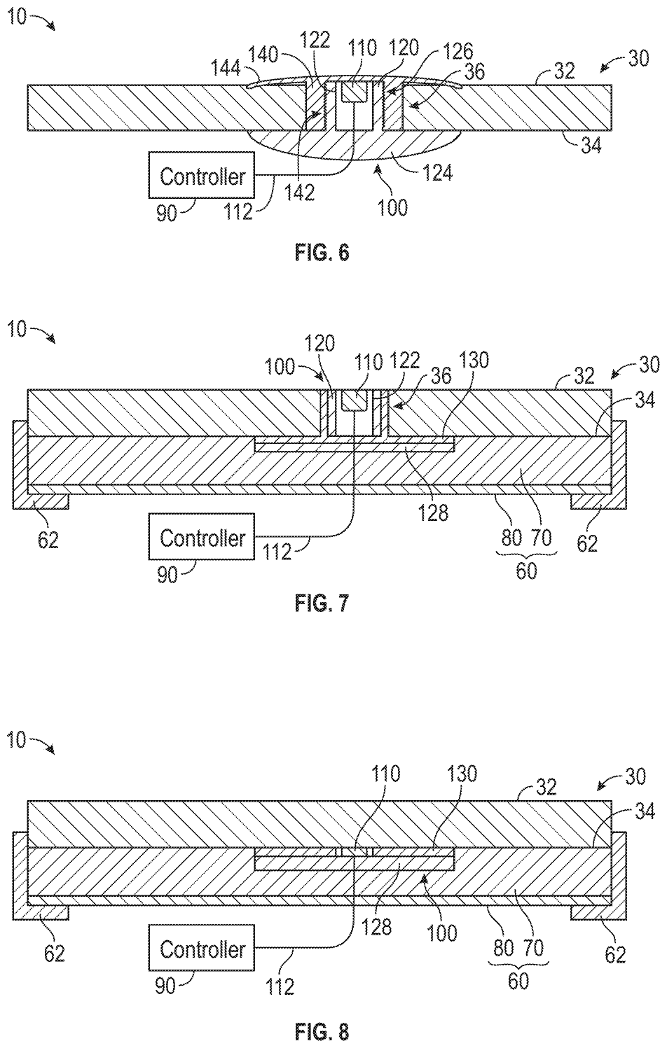

According to an exemplary embodiment, the sensor holder 120 is secured within the through-hole 36 such that the interface between the sensor holder 120 and the through-hole 36 is liquid-proof. Such a liquid-proof barrier or seal may prevent liquid from (i) seeping through the interface between through-hole 36 and the sensor holder 120 and (ii) damaging the electronic components disposed within the housing 20 (e.g., the thermal element 40, the controller 90, etc.). In some embodiments, the sensor holder 120 is threaded/screwed into the through-hole 36 (see, e.g., FIGS. 5 and 6). In some embodiments, the sensor holder 120 is additionally or alternatively secured within the through-hole 36 via a seal or a sealing material (e.g., a resilient member, a seal, an o-ring, adhesive, etc.) (see, e.g., FIG. 7). In some embodiments, the sensor holder 120 is additionally or alternatively secured within the through-hole 36 via an interference fit.

As shown in FIGS. 3-7, the sensor holder 120 defines a recess or cavity, shown as temperature sensor chamber 122, configured to receive the temperature sensor 110. According to the exemplary embodiment shown in FIGS. 3-7, the sensor holder 120 is positioned within the through-hole 36 and the temperature sensor 110 is positioned within the temperature sensor chamber 122 of the sensor holder 120 such that the temperature sensor 110 is positioned proximate, along, or at the upper surface 32 of the top plate 30 (e.g., flush with the upper surface 32 of the top plate 30, etc.). According to an exemplary embodiment, such positioning of the temperature sensor 110 proximate, along, or at the upper surface 32 facilitates acquiring more accurate temperature data with the temperature sensor 110 and/or improving response time to changes in temperature of a pan and/or the top plate 30 (e.g., the controller 90 can control the thermal element(s) 40 to more accurately provide the desired temperature of the cookware, etc.). According to an exemplary embodiment, the temperature sensor 110 is fixed within the temperature sensor chamber 122 (e.g., rigid, semi-rigid, not flexible, etc.). Traditional sensor assemblies include movable or flexible rubber diaphragms or thermistors on a spring. These flexible type of sensor assemblies are not suitable for a cooking environment because of spillage during cooking and ease of a pan moving or being pushed around the cooktop, which can damage the diaphragms or the spring-loaded thermistors. The fixed, rigid, or semi-rigid arrangement of the present temperature sensor 110 within the temperature sensor chamber 122 of the sensor holder 120 prevents such defects experienced by traditional flexible sensor arrangements.

As shown in FIG. 3, at least a portion of the sensor holder 120 is positioned within the through-hole 36. In some embodiments, the sensor holder 120 is secured within the through-hole 36 via adhesive (e.g., silicone, etc.). In some embodiments, a resilient member (e.g., a rubber seal, etc.) is positioned between the sensor holder 120 and the through-hole 36. In some embodiments, the through-hole 36 and the sensor holder 120 have threads that cooperatively engage with one another to secure the sensor holder 120 within the through-hole 36. In some embodiments, the insulation 60 is positioned beneath the top plate 30 and around the bottom end of the sensor holder 120.

As shown in FIGS. 4 and 5, the sensor holder 120 is positioned within the through-hole 36 and includes an extended portion, shown as flange 124, extending laterally outward from the bottom end thereof. The flange 124 is configured to be positioned along the lower surface 34 of the top plate 30. The flange 124 has a diameter that is greater than the diameter of the sensor holder 120 and the through-hole 36, and the sensor holder 120 extends from the flange 124 into the through-hole 36. As shown in FIG. 4, the flange 124 has a flat plate-like shape. As shown in FIG. 5, the flange 124 has a domed or curved shape (e.g., a mushroom shape, etc.). As shown in FIGS. 4 and 5, a sealing element, shown as seal 130, is positioned between the flange 124 and the lower surface 34 of the top plate 30. In one embodiment, the seal 130 is or include an adhesive (e.g., silicone, etc.) that secures the flange 124 to the lower surface 34 of the top plate 30 and/or seals the through-hole 36 (e.g., to prevent liquid from seeping therethrough into the housing 20, etc.). In another embodiment, the seal 130 is a resilient member (e.g., an o-ring, a rubber seal, etc.) that seals the through-hole 36 (e.g., to prevent liquid from seeping therethrough into the housing 20, etc.). In such an embodiment, the sensor holder 120 may be adhesively secured within the through-hole, threadably secured within the through-hole 36, and/or still otherwise secured therein (e.g., with an interference fit, etc.). As shown in FIG. 5, the exterior wall of the sensor holder 120 defines a plurality of retaining elements, shown as threads 126, configured to interface with the threads 38 of the through-hole 36 to secure the sensor holder 120 within the through-hole 36. In some embodiments, the insulation 60 is positioned beneath the top plate 30 and around the flange 124 of the sensor holder 120.

As shown in FIG. 6, the sensor assembly 100 includes a cover, shown as cap 144, having a elongated body, shown as insert 140, extending from the cap 144 and defining a slot, shown as recess 142. The insert 140 is received by the through-hole 36 of the top plate 30, the recess 142 receives the sensor holder 120, and the cap 144 engages the upper surface 32 of the top plate 30 and encloses the through-hole 36 of the top plate 30 and the temperature sensor chamber 122 of the sensor holder 120. In some embodiments, the inner surface of the recess 142 is threaded to cooperate with the threads 126 of the sensor holder 120. In some embodiments, the sensor holder 120 is additionally or alternatively adhesively secured within the recess 142. In some embodiments, the outer surface of the insert 140 is threaded to cooperate with the threads 38 of the through-hole 36. In some embodiments, the insert 140 is additionally or alternatively adhesively secured within the through-hole 36.

As shown in FIG. 7, the sensor assembly 100 includes the sensor holder 120 disposed within the through-hole 36 and a cover, shown as holding plate 128, positioned along the lower surface 34 of the top plate 30 and covering the through-hole 36, thereby securing the sensor holder 120 in the through-hole 36. According to an exemplary embodiment, the holding plate 128 is manufactured from mica. In other embodiments, the holding plate 128 is manufactured form another suitable material. As shown in FIG. 7, the seal 130 is positioned between (i) the holding plate 128 and the lower surface 34 of the top plate 30 and (ii) the sensor holder 120 and the through-hole 36. The seal 130 may be or include an adhesive (e.g., silicone, etc.) that secures the holding plate 128 to the lower surface 34 of the top plate 30, secures the sensor holder 120 within the through-hole 36, and/or seals the through-hole 36 (e.g., to prevent liquid from seeping therethrough into the housing 20, etc.).

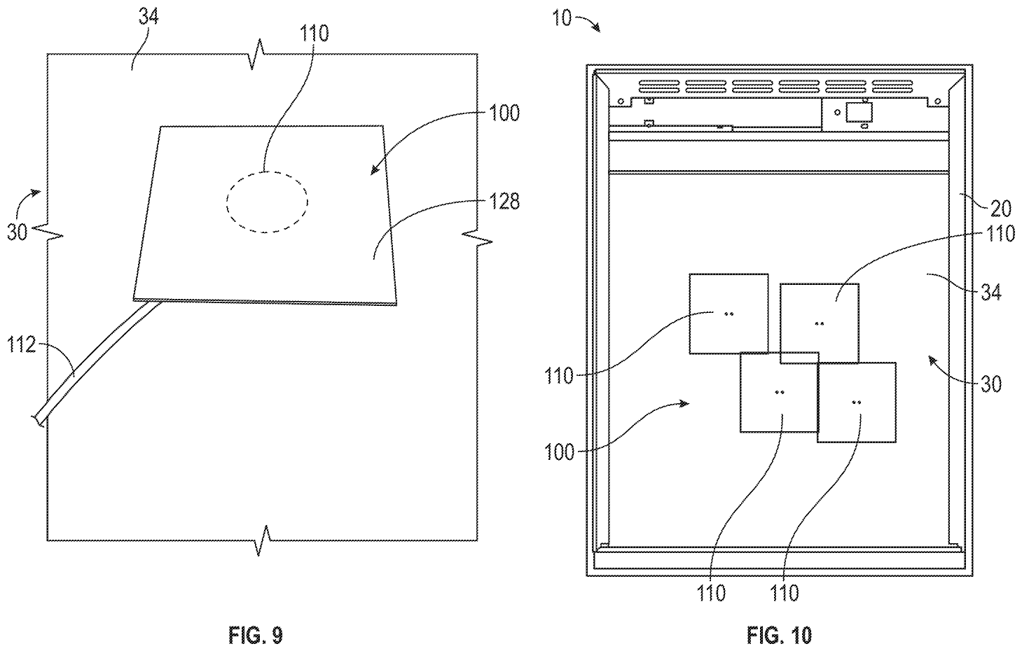

As shown in FIGS. 8 and 9, the sensor assembly 100 does not include the sensor holder 120, nor does the top plate 30 define the through-hole 36. Rather, the temperature sensor 110 is directly coupled to and positioned along the lower surface 34 of the top plate 30 with the seal 130 securing the holding plate 128 thereunder. In some embodiments, the lower surface 34 of the top plate 30 defines a recess, notch, or cutout that receives the temperature sensor 110 and the holding plate 128 is positioned to enclose the temperature sensor 110 within the recess, notch, or cutout.

As shown in FIGS. 10 and 11, the sensor assembly 100 includes a plurality of temperature sensors 110 variously positioned about the top plate 30. The temperature sensors 110 may be (i) coupled to and positioned along the lower surface 34 of the top plate 30 (see, e.g., FIGS. 8 and 9) and/or (ii) positioned proximate the upper surface 32 and disposed within the top plate 30 (see, e.g., FIGS. 3-7). Accordingly, the top plate 30 may define a plurality of through-holes 36 that are variously positioned about the top plate 30 (e.g., in embodiments where the sensor assembly 100 includes the sensor holders 120, etc.).

As shown in FIG. 11, each of the plurality of temperature sensors 110 is positioned at a different distance from a center 150 of the top plate 30. Specifically, a first temperature sensor 110 is positioned a first distance 152 from the center 150, a second temperature sensor 110 is positioned a second distance 154 from the center 150, a third temperature sensor 110 is positioned a third distance 156 from the center 150, and a fourth temperature sensor 110 is positioned a fourth distance 158 from the center 150. While the sensor assembly 100 is shown to include four temperature sensors 110, in other embodiments, the sensor assembly 100 includes a different number of temperature sensors 110 (e.g., two, three, five, six, etc.).

According to an exemplary embodiment, the first distance 152, the second distance 154, the third distance 156, and the fourth distance 158 are selected based on industry standard or common sizes of pans, pots, etc. By way of example, the first distance 152 may be four inches, the second distance 154 may be six inches, the third distance 156 may be eight inches, and the fourth distance 158 may be ten inches. By way of another example, the first distance 152 may be six inches, the second distance 154 may be eight inches, the third distance 156 may be ten inches, and the fourth distance 158 may be twelve inches. In some embodiments, the radial distance between adjacent temperature sensors 110 is two inches. In some embodiments, the radial distance between adjacent temperature sensors 110 in one inch. The radial spacing of the temperature sensors 110 may be dependent on the size of the top plate 30 and/or the number of the temperature sensors 110.

Induction ranges are often used to heat a variety of sizes of pans. The heating characteristics of the pan will vary depending on the size of the pan and material of construction. Traditional induction ranges typically include a single temperature sensor in the center of a ceramic top or just off center to detect the temperature of a pan being heated on the top surface. However, without knowing the size of the pan, the temperature measurement can lead to very inaccurate control of the temperature of the pan. Additionally, many pans have concave bottom surfaces that do not contact the center of the ceramic top. Thus, the temperature sensor under the top is measuring the heat of the air trapped under the pan, not the pan itself, which is not an accurate measurement of pan temperature.

According to an exemplary embodiment, the temperature data acquired by each of the plurality of temperature sensors 110 facilitates estimating (e.g., by the controller 90, etc.) a diameter of the item of cookware (e.g., a pan, a pot, etc.) positioned along the upper surface 32 of the top plate 30. The estimated diameter of the item of cookware may be used by the controller 90 to improve the operation of the temperature-regulating appliance 10. By way of example, the controller 90 may be configured to monitor the temperature recorded at each of the plurality of temperature sensors 110. In an induction range implementation, only the areas where the conductive material of the item of cookware is present will the top plate 30 be at an elevated temperature. Accordingly, the presence of heat or lack thereof at each of the temperature sensors 110 can be used by the controller 90 to determine where the item of cookware is positioned on the top plate 30 and estimate its diameter based thereon. For example, if the first temperature sensor 110 and the second temperature sensor 110 are recording elevated temperatures relative to the third temperature sensor 110 and the fourth temperature sensor 110, the controller 90 may be configured to estimate that the item of cookware has diameter that is approximately the same as twice the second distance 154 of the second temperature sensor 110 from the center 150 of the top plate 30.

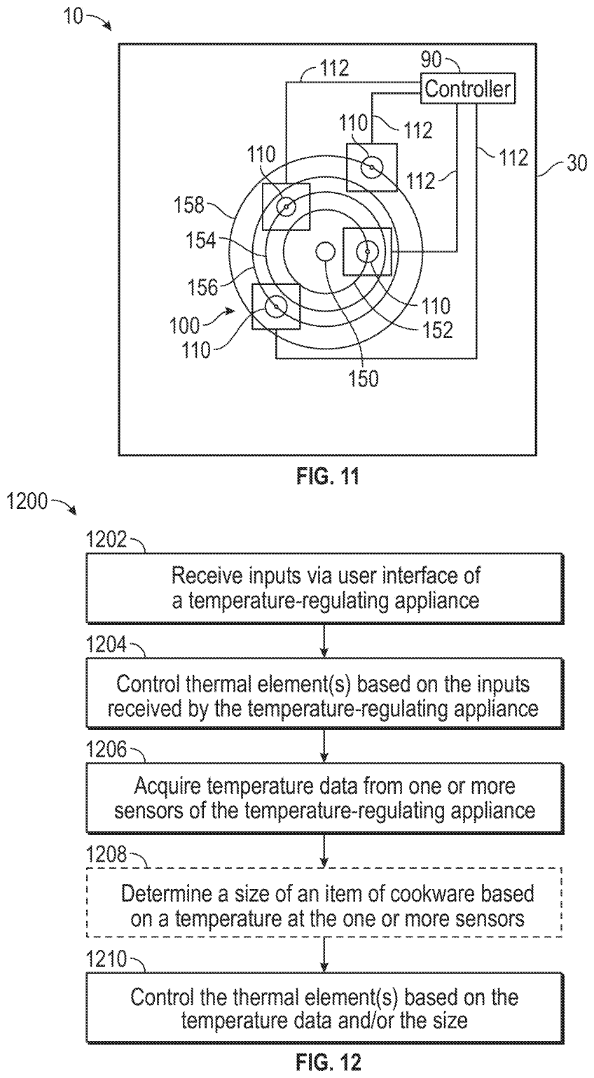

Referring now to FIG. 12, a method 1200 for controlling operation of an appliance is shown, according to an exemplary embodiment. At step 1202, a controller (e.g., the controller 90, etc.) is configured to receive inputs (e.g., an on command, a temperature command, etc.) via a user interface (e.g., the user interface 50, etc.) of a temperature-regulating appliance (e.g., the temperature-regulating appliance 10, an induction range, etc.). At step 1204, the controller is configured to control one or more thermal elements (e.g., the thermal element(s) 40, an inductive heating element, etc.) of the temperature-regulating appliance based on the inputs received by the temperature-regulating appliance.

At step 1206, the controller is configured to acquire temperature data from one or more sensors (e.g., the temperature sensors 110, etc.) of the temperature-regulating appliance. The temperature data may be indicative of a temperature of a plate (e.g., the top plate 30, etc.) of the temperature-regulating appliance and/or an item of cookware positioned along the plate. The one or more temperature sensors may be variously positioned about the plate at different distances from the center thereof. In some embodiments, the one or more temperatures sensors are disposed within the plate (e.g., within the through-holes 36, etc.), proximate a top surface (e.g., the upper surface 32, etc.) thereof. In some embodiments, the one or more temperature sensors are additionally or alternatively positioned along a bottom surface (e.g., the lower surface 34, etc.) of the plate.

Step 1208 may be optional (e.g., step 1208 may be performed in embodiments where the temperature-regulating appliance 10 includes a plurality of temperature sensors 110, etc.). At step 1208, the controller is configured to determine a size of the item of cookware positioned along the plate based on the temperature at the one or more sensors. At step 1210, the controller is configured to adaptively control the one or more thermal elements based on the temperature data and/or the size of the item of cookware.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data that cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the temperature-regulating appliance 10 and the components thereof (e.g., the housing 20, the top plate 30, the thermal element 40, the user interface 50, the controller 90, the sensor assembly 100, etc.) as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A temperature-regulating appliance comprising:
a housing defining an internal chamber;
a plate coupled to the housing and enclosing the internal chamber, the plate having a top surface and a bottom surface;
a thermal element positioned beneath the plate and within the internal chamber; and
a temperature sensor at least one of (i) coupled to and positioned along the bottom surface of the plate or (ii) positioned proximate the top surface and disposed within the plate, wherein the temperature sensor is configured to acquire temperature data regarding a temperature of at least one of (i) the plate or (ii) an item of cookware positioned along the top surface of the plate.

2. The temperature-regulating appliance of claim 1, further comprising an insulating layer positioned between the plate and the thermal element.

3. The temperature-regulating appliance of claim 2, further comprising a seal positioned around a periphery of the plate and the insulating layer to form a liquid-proof barrier.

4. The temperature-regulating appliance of claim 1, wherein the thermal element includes at least one of an inductive heating element, a non-inductive heating element, or a cooling element.

5. The temperature-regulating appliance of claim 1, wherein the temperature sensor includes at least one of a thermistor, a thermocouple, a resistance temperature detection sensor, an infrared sensor, or a negative temperature coefficient thermistor.

6. The temperature-regulating appliance of claim 1, wherein the temperature sensor included a plurality of temperature sensors, wherein each of the plurality of temperature sensors is positioned at a different distance from a center of the plate, and wherein the temperature data acquired by each of the plurality of temperature sensors facilitates estimating a diameter of the item of cookware positioned along the top surface of the plate.

7. The temperature-regulating appliance of claim 1, wherein the temperature sensor is coupled to and positioned along the bottom surface of the plate.

8. The temperature-regulating appliance of claim 1, wherein the temperature sensor is positioned proximate the top surface and disposed within the plate.

9. The temperature-regulating appliance of claim 8, wherein the plate defines an aperture that extends at least partially from the top surface of the plate through a thickness of the plate.

10. The temperature-regulating appliance of claim 9, further comprising a sensor holder positioned within the aperture, the sensor holder defining a sensor chamber that receives the temperature sensor.

11. The temperature-regulating appliance of claim 10, wherein the sensor holder is rigidly or semi-rigidly secured within the aperture such that the sensor holder and the temperature sensor are fixed within the plate.

12. The temperature-regulating appliance of claim 11, wherein the sensor holder is at least one of (i) threadably secured within the aperture or (ii) adhesively secured within the aperture.

13. The temperature-regulating appliance of claim 10, wherein the aperture extends through the entire thickness of the plate.

14. The temperature-regulating appliance of claim 13, wherein the sensor holder includes a flange positioned at a bottom end thereof, the flange having a diameter larger than the aperture, the flange configured to engage the bottom surface of the plate.

15. The temperature-regulating appliance of claim 14, further comprising a seal positioned between the flange and the bottom surface of the plate.

16. A temperature-regulating appliance comprising:
a housing defining an internal chamber;
a plate coupled to the housing and enclosing the internal chamber, the plate having a top surface and a bottom surface, the plate defining an aperture that extends at least partially from the top surface through a thickness of the plate;
a thermal element positioned beneath the plate and within the internal chamber; and
a sensor assembly comprising:
a holder positioned within the aperture, the holder defining a sensor chamber; and
a temperature sensor disposed within the sensor chamber such that the temperature sensor is positioned proximate the top surface of the plate;
wherein the sensor assembly is flush with the top surface of the plate.

17. The temperature-regulating appliance of claim 16, further comprising a plurality of sensor assemblies, wherein the plate defines a plurality of apertures, wherein each of the plurality of apertures is positioned at a different distance from a center of the plate, and wherein each of the plurality of sensor assemblies is positioned within a respective one of the plurality of apertures.

18. A temperature-regulating appliance comprising:
a housing defining an internal chamber;
a plate coupled to the housing and enclosing the internal chamber, the plate having a top surface and a bottom surface;
a thermal element positioned beneath the plate and within the internal chamber; and
a plurality of temperature sensors positioned to acquire temperature data regarding a temperature of at least one of (i) the plate or (ii) an item of cookware positioned along the top surface of the plate;
wherein each of the plurality of temperature sensors is positioned at a different distance from a center of the plate; and
wherein the temperature data acquired by each of the plurality of temperature sensors facilitates estimating a diameter of the item of cookware positioned along the top surface of the plate.

19. The temperature-regulating appliance of claim 18, wherein the plurality of temperature sensors are positioned along and coupled to the bottom surface of the plate.

20. The temperature-regulating appliance of claim 18, wherein the plate defines a plurality of apertures that extend at least partially through a thickness of the plate, wherein each of the plurality of temperature sensors is positioned within a respective one of the plurality of apertures.
